(19) United States
(12) Patent Application Publication
(10) Pub. No.: US 2016/0046031 A1
(43) Pub. Date: Feb. 18, 2016

(54) ROTARY BLADE ASSEMBLY FOR CUTTING A FOOD PRODUCT INTO HELICAL STRIPS

(71) Applicant: McCain Foods Limited, Florenceville-Bristol (CA)

(72) Inventors: David M. Rogers, Woodstock (CA); John Warren Aikens, New Maryland (CA); Carlos Rincon, Florenceville-Bristol (CA)

(21) Appl. No.: 14/459,854

(22) Filed: Aug. 14, 2014

(51) Int. Cl. B26D 3/11; B26D 1/00; B26D 1/29

(52) U.S. Cl. CPC B26D 3/11; B26D 1/29; B26D 1/0006; B26D 2001/006

(57) ABSTRACT

A rotary blade assembly for cutting a food product into helical strips is disclosed. The rotary blade assembly includes a substantially spiral-shaped blade holder for mounting in a food product flow path, and a plurality of axially extending slitter blades connected to the blade holder. The blade holder includes an axis of rotation, an upstream surface, an upstream end and a downstream end. The upstream end is axially spaced apart from the downstream end to define a radial slot. A radial cutting edge is positioned adjacent the radial slot. Each slitter blade extends upstream of the upstream surface and includes a slitter cutting edge. At least a portion of the slitter cutting edge of at least one of the slitter blades extends substantially non-perpendicularly to the upstream surface toward or away from the axis of rotation.

### FIELD

This application relates to the field of cutting food products, such as fruit or vegetables.

### INTRODUCTION

This application relates to blade assemblies for making cut food products. More particularly, this application relates to blade assemblies comprising a plurality of slitter blades for cutting food products into helical food pieces.

### SUMMARY

In a first aspect, a rotary blade assembly for cutting a food product into helical strips is provided. The rotary blade assembly may comprise a substantially spiral-shaped blade holder for mounting in a food product flow path and a plurality of axially extending slitter blades connected to the blade holder. The blade holder may comprise an axis of rotation, an upstream surface, an upstream end and a downstream end. The upstream end may be axially spaced apart from the downstream end to define a radial slot. A radial cutting edge may be adjacent the radial slot. Each slitter blade may extend upstream of the upstream surface, and include a slitter cutting edge. At least a portion of the slitter cutting edge of at least one of the slitter blades may extend substantially non-perpendicularly to the upstream surface toward or away from the axis of rotation.

In some embodiments, at least a portion of each slitter cutting edge may be curved.

In some embodiments, at least one of the slitter blades of the plurality of slitter blades may be in contact with an adjacent other slitter blade of the plurality of slitter blades.

In some embodiments, the slitter cutting edge of at least one of the slitter blades may form a closed shape.

In some embodiments, the slitter cutting edge may comprise at least a first portion and a second portion, the first and second portions extending in different directions in the plane that is substantially parallel to the axis of rotation.

In some embodiments, the slitter cutting edge of alternate slitter blades may be substantially perpendicular to the upstream surface.

In some embodiments, the portion of each slitter cutting edge may be undulating.

In some embodiments, the slitter cutting edge of each slitter blade may be arcuate.

In some embodiments, the slitter cutting edge of each slitter blade may be crescent shaped.

In some embodiments, the slitter cutting edge of each slitter blade may be circular.

In some embodiments, the slitter cutting edge of each slitter blade may be zigzagged.

In some embodiments, each slitter blade may extend from the downstream end to the upstream end of the blade holder.

In some embodiments, the rotary blade assembly may further comprise a slitter pack removably mounted to the blade holder, the slitter pack including the plurality of slitter blades.

In some embodiments, each of the plurality of slitter blades may be positioned a different radial distance from the axis of rotation.

In some embodiments, the blade holder may further comprise a slab blade removably mounted proximate the upstream end, the slab blade including the radial cutting edge.

In another aspect, a rotary blade assembly for cutting a food product into helical strips is provided. The rotary blade assembly may comprise a blade holder and a plurality of slitter blades. The blade holder may have an axis of rotation, an upstream surface, and a radially extending leading edge spaced from at least a portion of the upstream surface to define a slot having an axial height and a radial width. Each slitter blade may extend axially away from the upstream surface and include a cutting edge. At least a portion of the cutting edge of at least one of the slitter blades may extend substantially non-perpendicularly to the upstream surface in a plane substantially parallel to the axis of rotation.

In some embodiments, at least a portion of each cutting edge may be curved.

In some embodiments, at least one of the slitter blades of the plurality of slitter blades may be in contact with an adjacent other slitter blade of the plurality of slitter blades.

In some embodiments, the cutting edge of at least one of the slitter blades may form a closed shape.

In some embodiments, the cutting edge of each of the plurality of slitter blades may include at least a first portion and a second portion, the first and second portions extending in different directions in the plane that is substantially parallel to the axis of rotation.

In another aspect, a rotary blade assembly for cutting a food product into helical strips is provided. The rotary blade assembly may comprise a blade holder and a plurality of slitter blades. The blade holder may have an axis of rotation, an upstream surface, and a radially extending leading edge spaced from at least a portion of the upstream surface to define a slot having an axial height and a radial width. Each slitter blade may extend axially away from the upstream surface and include a cutting edge. At least a portion of the cutting edge of at least one of the slitter blades may extend toward or away from the axis of rotation when viewed in profile through a viewing plane that is parallel to the axis of rotation.

### DRAWINGS

FIG. 1 is a schematic view of a hydraulic cutting system, in accordance with at least one embodiment;

FIG. 2A is a perspective view of a blade assembly in accordance with at least one embodiment;

FIG. 2B is a top plan view of the blade assembly of FIG. 2A;

FIG. 2C is a side elevation view of the blade assembly of FIG. 2A;

FIG. 3A is a perspective view of the blade assembly of FIG. 2A, a whole potato, and a sliced potato, in accordance with at least one embodiment;

FIG. 3B is a perspective view of potato pieces cut by the blade assembly of FIG. 2A, in accordance with at least one embodiment;

FIG. 4A is a perspective view of a blade assembly including a slitter pack, in accordance with another embodiment;

FIG. 4B is an exploded perspective view of the blade assembly of FIG. 4A;

FIG. 5A is an exploded perspective view of a blade assembly including a mounting fixture, in accordance with another embodiment;

FIG. 5B is a top plan view of the blade assembly of FIG. 5A;

FIG. 5C is a front elevation view of the blade assembly of FIG. 5A;

FIG. 6 is a perspective view of a food cutting device including the blade assembly of FIG. 5A, in accordance with at least one embodiment;

FIG. 7A is a perspective view of a blade assembly in accordance with another embodiment;

FIG. 7B is a top plan view of the blade assembly of FIG. 7A;

FIG. 7C is a front elevation view of the blade assembly of FIG. 7A;

FIG. 7D is a perspective view of the blade assembly of FIG. 7A, a whole potato, and a sliced potato in accordance with at least one embodiment;

FIG. 7E is a perspective view of potato pieces cut by the blade assembly of FIG. 7A, in accordance with at least one embodiment;

FIG. 8A is a perspective view of a blade assembly in accordance with another embodiment;

FIG. 8B is a front elevation view of the blade assembly of FIG. 8A;

FIG. 8C is a perspective view of the blade assembly of FIG. 8A, a pre-piercing blade, a pre-pierced whole potato, and a sliced potato, in accordance with at least one embodiment;

FIG. 8D is a perspective view of potato pieces cut by the blade assembly of FIG. 8A and the pre-piercing blade of FIG. 8C, in accordance with at least one embodiment;

FIG. 9A is a perspective view of a blade assembly in accordance with another embodiment;

FIG. 9B is a front elevation view of the blade assembly of FIG. 9A;

FIG. 10A is a perspective view of a blade assembly in accordance with another embodiment;

FIG. 10B is a front elevation view of the blade assembly of FIG. 10A;

FIGS. 10C-10F are perspective, top plan, front elevation, and side elevation views, respectively, of a potato piece cut by the blade assembly of FIG. 10A;

FIG. 11A is a perspective view of a blade assembly in accordance with another embodiment;

FIG. 11B is a front elevation view of the blade assembly of FIG. 11A;

FIGS. 11C-11F are perspective, top plan, front elevation, and side elevation views, respectively, of a potato piece cut by the blade assembly of FIG. 11A;

FIG. 12A is a perspective view of a blade assembly in accordance with another embodiment;

FIG. 12B is a front elevation view of the blade assembly of FIG. 12A;

FIGS. 12C-12F are perspective, top plan, front elevation, and side elevation views, respectively, of a potato piece cut by the blade assembly of FIG. 12A;

FIG. 13A is a perspective view of a blade assembly in accordance with another embodiment;

FIG. 13B is a front elevation view of the blade assembly of FIG. 13A;

FIGS. 13C-13F are perspective, top plan, front elevation, and side elevation views, respectively, of a potato piece cut by the blade assembly of FIG. 13A;

FIG. 14A is a perspective view of a blade assembly in accordance with another embodiment;

FIG. 14B is a front elevation view of the blade assembly of FIG. 14A;

FIG. 15A is a perspective view of a blade assembly in accordance with another embodiment; and

FIG. 15B is a front elevation view of the blade assembly of FIG. 15A.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

For convenience, the description below will refer to potatoes as the food product being cut. Those skilled in the art will appreciate that the embodiments of the blade assembly and food cutting device described herein may be used to cut any suitable product, including without limitation food products (such as fruit and vegetables), wood, and fibrous materials (such as bamboo).

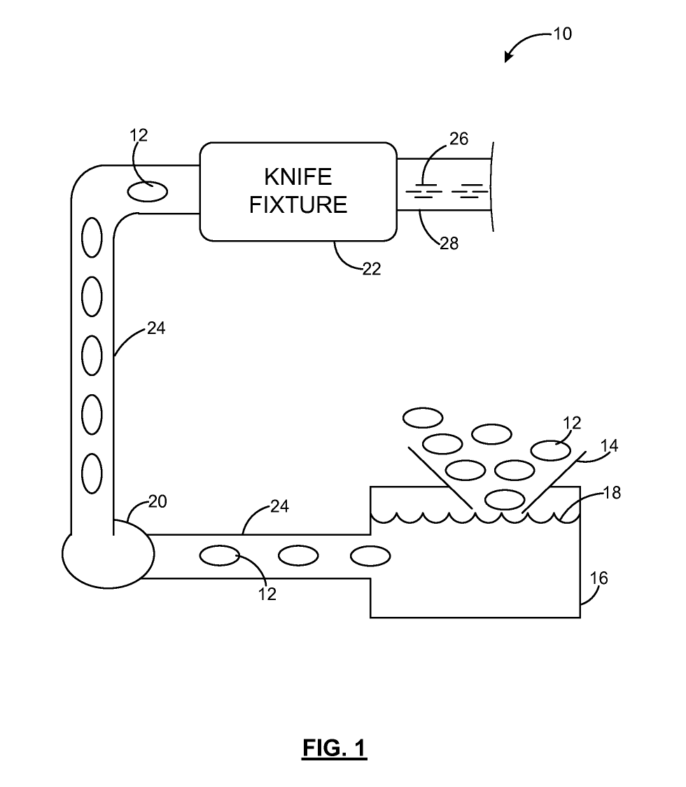

FIG. 1 shows a schematic view of a hydraulic cutting system 10, in accordance with at least one embodiment. In the example shown, food products 12 (e.g. whole fruit, vegetables, or other food items) are fed from a hopper 14 into a tank 16 in which they are submersed in water 18. As shown, a plurality of conduits 24 connect tank 16 to a pump 20, and pump 20 to a knife fixture 22.

In the illustrated example, pump 20 circulates water 18 from tank 16 to thereby entrain food products 12 to travel through conduits 24 to knife fixture 22. In some examples, conduits 24 are sized to receive food products 12 in single file. For example, conduits (e.g. pipes) 24 may have a diameter that is greater than a diameter of one food product 12, and less than the diameter of two food products 12. In alternative embodiments, conduits 24 may be sized to receive two or more food products 12 in parallel. For example, conduits 24 may have a diameter that is greater than a diameter of at least two food products 12.

In the example shown, food products 12 travel through conduits 24 toward knife fixture 22 at a velocity imparted to them by pump 20. Knife fixture 22 includes an embodiment of a blade assembly (not shown in FIG. 1) described in detail below. As food products 12 travel through knife fixture 22, they are cut into smaller pieces 26 and discharged through outlet conduit 28. Optionally, smaller pieces 26 are subjected to subsequent processing (e.g. cooking, parfrying, freezing, packaging etc.). In some embodiments, food products 12 are raw potatoes, and smaller pieces 26 are processed into French fries. Knife fixture 22 includes a food cutting device, which in turn includes a blade assembly 100 as described in more detail below.

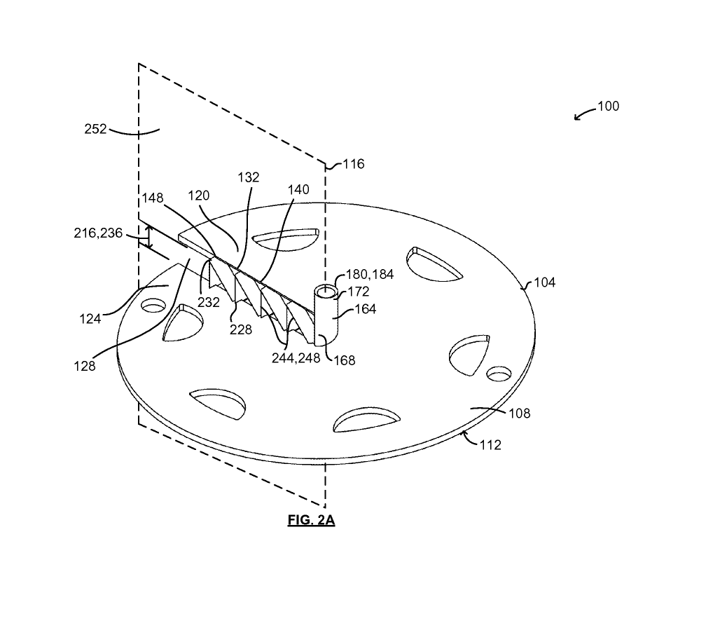

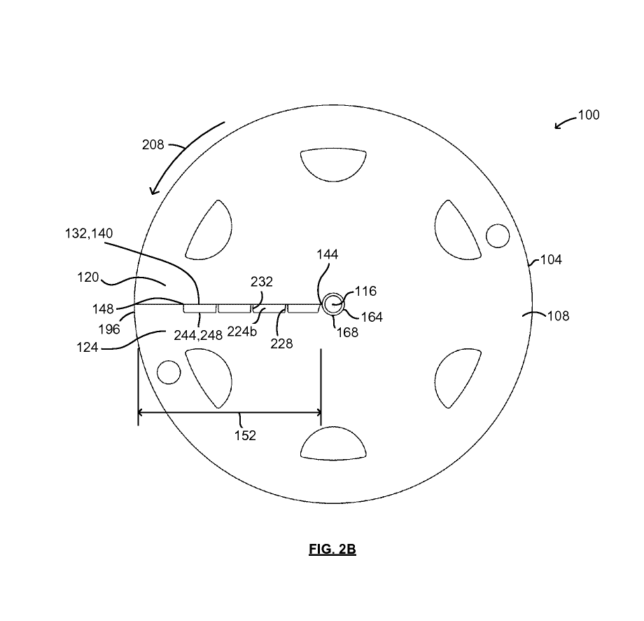

Reference is now made to FIGS. 2A-2C, which show a blade assembly 100 in accordance with at least one embodiment. In the example shown, blade assembly 100 includes a blade holder 104 having an upstream surface 108, a downstream surface 112, and an axis of rotation 116. As used herein and in the claims, the term “axial” means in a direction parallel to the axis of rotation 116, and the term “radial” means in a direction substantially perpendicular to and intersecting the axis of rotation 116.

Blade holder 104 may have any configuration suitable for cutting potatoes into spiral slabs. In the illustrated example, blade holder 104 is substantially spiral shaped. As shown, upstream surface 108 extends from an upstream end 120 around axis 116 and axially downstream to a downstream end 124. Preferably, blade holder 104 extends at least one rotation (i.e. about 360 degrees) around axis 116 between upstream and downstream ends 120, 124, respectively. In this case, axially spaced apart upstream and downstream ends 120 and 124 may define a radially extending slot 128. A radially extending cutting edge 132 may be provided along the upstream edge 140 of slot 128.

As used herein and in the claims, a cutting edge refers to an exposed edge intended to cut a food product. For example, a cutting edge may be sharpened or sufficiently thin to slice into a food product that strikes the cutting edge. A cutting edge may have any suitable edge finish, such as straight, serrated, and saw-toothed. Further a cutting edge may be configured to form an incision with any suitable texture. For example, a cutting edge may be straight for making straight cuts, wavy for making wavy cuts, or crinkled for making crinkle cuts.

Cutting edge 132 may be integrally formed with blade holder 104, or attached thereto. In the illustrated example, cutting edge 132 is integrally formed with blade holder 104 along the upstream edge 140. Alternatively, a cutting edge may be provided adjacent slot 128 by attaching a discrete slab blade to upstream end 120. In this case, the attached slab blade is preferably mounted to blade holder 104, which may permit the slab blade to be removed and replaced, e.g. if the slab blade becomes dull or damaged.

Preferably, cutting edge 132 is located along an upstream edge 140 of slot 128. Cutting edge 132 extends radially from an inboard cutting edge end 144 to an outboard cutting edge end 148 across a radial width 152 of slot 128. In the illustrated example, slot 128 extends in width from an inboard side 156 to an open outboard side 160. As shown, inboard end 144 of cutting edge 132 may be adjacent, or more preferably coterminous, with inboard side 156 of slot 128. Alternatively, inboard end 144 may be spaced radially inwardly or outwardly from inboard side 156. Further, as shown, outboard end 148 of cutting edge 132 may be spaced radially inwardly from outboard side 160 of slot 128. Alternatively, outboard end 148 of cutting edge 132 may be adjacent to, coterminous with, or radially outboard of outboard side 160.

Inboard side 156 of slot 128 may be closed or open ended. In the illustrated example, blade assembly 100 includes an optional central support 164 joined to blade holder 104. As shown, central support 164 extends axially along axis 116 of rotation of blade holder 104. Central support 164 may include an axially extending sidewall 168 that defines a closed inboard side of slot 128. In one aspect, central support 164 may provide structural support to blade assembly 100 for withstanding repeated impacts of food products. In another aspect, central support 164 may help to keep food products axially aligned with axis 116 as they are cut by blade assembly 100. By axially puncturing each food product as it passes through blade assembly 100, central support 164 may inhibit the food product from moving off-axis.

Central support 164 may include a pointed upstream tip for spearing each food product, or as shown, may be configured as a hollow cylinder for coring (i.e. cutting out the core of) each food product. As shown, axial sidewall 168 is cylindrically shaped and defines a hollow interior that extends from an upstream end 172 to a downstream end 176. Preferably, a cutting edge 180 is provided along an edge 184 bordering upstream end 172. Cutting edge 180 may be integrally formed with edge 184 (e.g. by sharpening edge 184 or providing edge 184 with a diminutive thickness) as shown, or a discrete coring blade (not shown) may be mounted (e.g. removably mounted) to edge 184. A diameter of central support 164 may define the diameter of the bore that central support 164 cuts into each food product. In some embodiments, central support 164 is removably mounted to blade holder 104. This may permit central support 164 to be removed and replaced when dull or damaged.

In alternative embodiments, blade assembly 100 may not include a central support 164. In this case, an inboard side 156 of slot 128 may be open. For example, inboard side 156 may be defined between an axial line extending from an inboard end of edge 140 and the portion of upstream surface 108 below.

Outboard side 160 of slot 128 may be open or closed. In the illustrated example, outboard side 160 is an open side defined by an axial line extending between outboard edge 188 of upstream end 120, and outboard edge 192 of downstream end 124. In alternative embodiments, blade holder 104 or blade assembly 100 more generally, may include a perimeter wall (not shown) that defines a closed outboard side to slot 128.

Slot 128 may extend in width radially outwardly away from axis 116 across any suitable portion of blade holder 104. In the illustrated example, inboard side 156 is spaced radially inboard of axis 116 and corresponds to sidewall 168 of central support 164. In alternative embodiments, such as where blade assembly 100 does not include a central support 164, inboard side 156 may be coincident with axis 116. As shown, outboard side 160 is coincident with the outermost edge 196 of blade holder 104. In alternative embodiments, outboard side 160 may be positioned inboard of outer edge 196 of blade holder 104. For example, slot 128 may be defined by an upstanding flap on a planar disc-shaped blade holder, such described in U.S. Pat. No. 5,010,796.

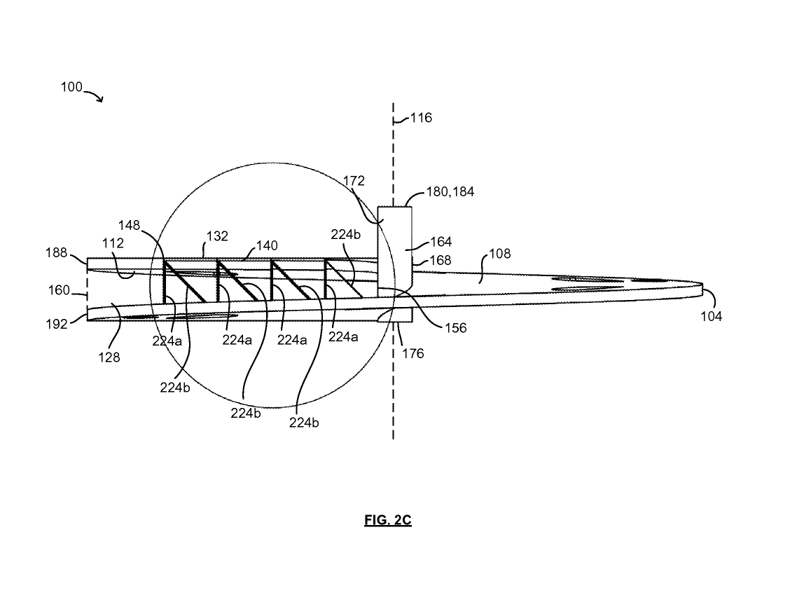

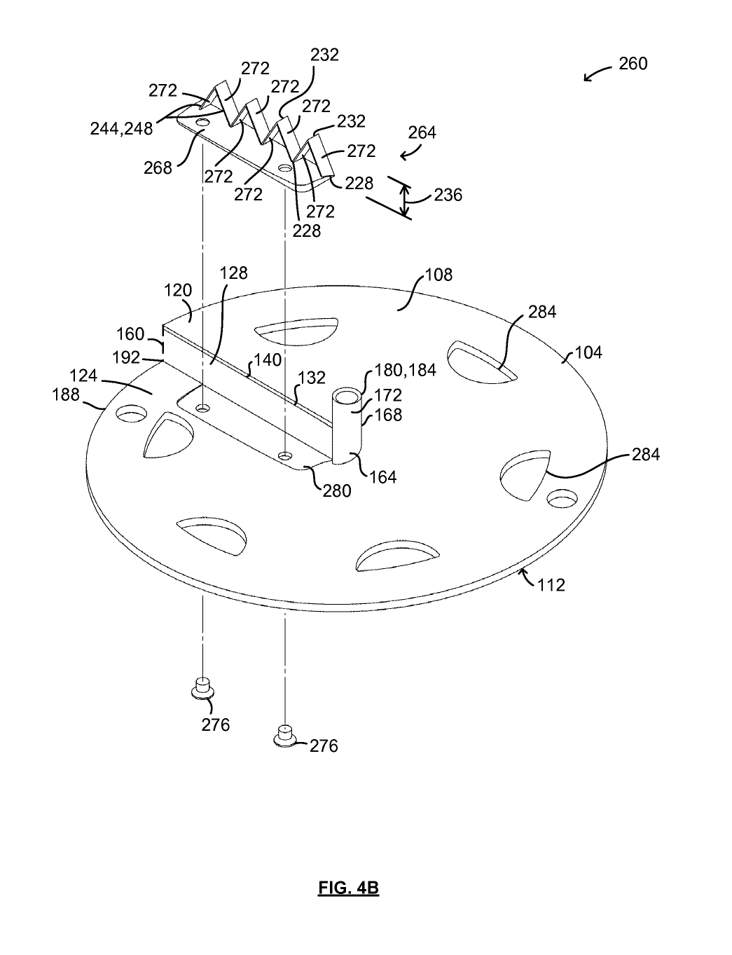

Reference is now made to FIG. 3A, which shows blade assembly 100, an uncut potato 200, and a potato piece 204 sliced by blade assembly 100. In operation, potato 200 is propelled as described with reference to FIG. 1 toward upstream surface 108 of blade holder 104 in a direction substantially in parallel with axis 116 of rotation. At the same time, blade holder 104 is driven as described below with reference to FIG. 6 to rotate about axis 116. Direction 208 of rotation is selected so that slot 128 is defined by a radially extending leading edge 140 axially spaced apart from a downstream portion 124 of upstream surface 108 (see FIG. 2A). As used herein and in the claims, a leading edge refers to an edge that faces in the direction of movement of that edge. As shown in FIG. 2B, leading edge 140 moves along a circular path and faces in the direction 208 of rotation.

After potato 200 contacts upstream surface 108, cutting edge 132 makes a spiral cut through potato 200 until sliced potato piece 204 is formed. Note that for clarity, sliced potato piece 204 does not account for the entirety of potato 200. Some pieces, such as the front and rear ends, have been omitted. As shown, potato piece 204 has a spiral shape with a cross-sectional height 212 that correspond to the axial height 216 of slot 128. Accordingly, axial height 216 of slot 128 may be chosen to select a cross-sectional height 212 of the resultant potato pieces.

Preferably, blade assembly 100 includes a plurality of slitter blades for dividing the spiral slab cut by blade holder 104 into smaller potato pieces. Various embodiments of slitter blades are disclosed herein which form potato pieces having non-rectangular (and non-square) cross-sections. In some cases, the size and cross-sectional shape of the potato pieces cut by these slitter blades may provide better grip, improved condiment application, visual appeal, more even cooking, and/or other benefits.

Reference is now made to FIGS. 2A-2C, and 3A-3B. In the illustrated example, blade assembly 100 includes a plurality of slitter blades 224. Each slitter blade 224 is shown extending between blade holder upstream and downstream ends 120 and 124. In the example shown, a lower end 228 of each slitter blade 224 is in contact with upstream surface 108 at downstream end 124, and an upper end 232 of each slitter blade 224 is in contact with downstream surface 112 at upstream end 120. In alternative embodiments, lower end 228 of slitter blades 224 may be connected to a common base to form a slitter pack (example described below) that can be removably secured to blade holder 104.

Preferably, an axial height 236 of each slitter blade 224 from lower end 228 to upper end 232 (as measured in parallel to axis 116) is equal to or greater than axial height 216 of slot 128. This may permit each slitter blade 224 to cut across the entire cross-sectional height 212 of potato piece 204 to divide potato piece 204 into discrete smaller pieces 240. In alternative embodiments, the axial height 236 of a slitter blade may be less than the axial height 216 of slot 128. For example, this may permit a slitter blade that forms a closed shaped (examples described below) to cut the entire cross-sectional shape of a smaller potato piece 240.

Each slitter blade 224 includes a leading cutting edge 244. Cutting edge 244 may be integrally formed with leading edge 248 of slitter blade 224 (e.g. by sharpening leading edge 248, or by providing leading edge 248 with a diminutive thickness) as shown, or a discrete blade may be mounted to leading edge 248. Further, each cutting edge 244 may extend the full length of leading edge 248, or extend along only a portion of leading edge 248. In the example shown, each cutting edge 244 extends from lower end 228 to upper end 232. In alternative embodiments, lower and upper ends of cutting edge 244 may be different from lower and upper ends of slitter blades 224.

Preferably, each slitter blade 224 is positioned at a different radial distance from axis 116 than each other slitter blade 224. This may permit each slitter blade 224 to form distinct cuts across the cross-section of potato piece 204. In the illustrated example, slitter blades 224 are aligned next to each other. As shown, an upper end 232 of each cutting edge 244 is in contact with an upper end 232 of an adjacent cutting edge 244, and a lower end 228 of each cutting edge 244 is spaced apart from a lower end 228 of an adjacent cutting edge 244. Optionally, one or more contacting pairs of cutting edge ends 228 or 232 may be permanently joined together in any suitable fashion, such as by welding. This may enhance the structural rigidity of slitter blades 224 for withstanding cutting stresses. Alternatively, any two or more slitter blades 224 may be integrally formed. As used herein and in the claims, “a plurality of slitter blades” means a plurality of discrete slitter blades, whether connected or disconnected from each other, or an integrally formed plurality of slitter blades provided as a unitary slitter blade.

Preferably, slitter blades 224 cut potato piece 204 to form smaller potato pieces 240 having a non-rectangular (and non-square) cross-section. Generally, square or rectangular cross-sectional profiles are formed by pairs of radially spaced apart slitter blades 224 that extend substantially in parallel with axis 116 or substantially perpendicularly to upstream surface 108. Such blades 224 may form right-angled cuts in combination with cutting edge 140 of blade holder 104.

In the illustrated example, slitter blades 224 in combination with blade holder 104 cut potato 200 into a plurality of smaller potato pieces 240 having right-angled triangular cross-sections. As shown, slitter blades 224 include a plurality of alternating slitter blades 224a and 224b. Slitter blades 224a have cutting edges 244 that extend substantially in parallel to axis 116 of rotation. Slitter blades 224b have cutting edges 244 that extend non-perpendicularly to the upstream surface 108 away from the axis 116 of rotation. In this example, slitter blades 224b may be described as extending at an angle to (i.e. non-perpendicularly to) upstream surface 108 in a plane 252 parallel to axis 116. Generally, when a slitter blade is seen to angle toward or away from axis 116 when viewed in profile from a plane parallel to axis 116 (such as plane 252 for example), that slitter blade may produce a non-orthogonal cut such that the resultant potato piece 240 may have a non-rectangular (and non-square) cross-section.

Slitter blades 224 may be positioned at any suitable circumferential position about axis 116. In the illustrated example, all of slitter blades 224 are positioned in a same circumferential position, such that they align with a common radius. As shown, slitter blades 224 are positioned between upstream and downstream ends 120, 124 of blade holder 104. Preferably, slitter blades 224 are connected to upstream and downstream ends of blade holder 104 in any suitable fashion, such as by welding. In alternative embodiments, one or more of slitter blades 224 may be positioned in a different circumferential position about axis 116. For example, slitter blades 224 may be distributed between a range of circumferential positions about axis 116.

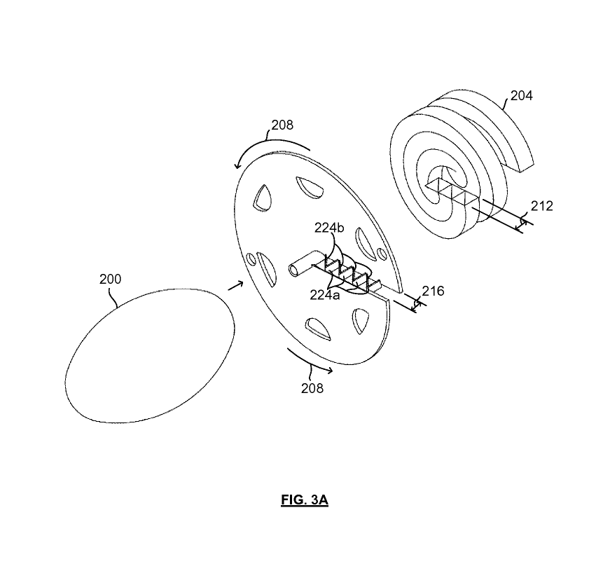

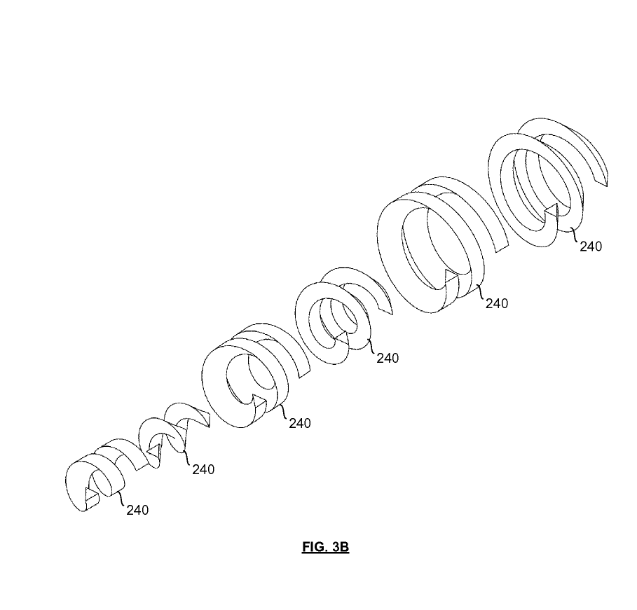

Optionally, blade assembly 100 may include a plurality of slitter blades removably mounted to blade holder 104. This may permit the slitter blades to be removed and replaced when dull or damaged. Reference is now made to FIGS. 4A and 4B, where like reference numerals refer to like parts in previous figures, and where an exemplary blade assembly 260 including a removably mountable slitter pack 264 is shown. In the illustrated example, slitter pack 264 includes a base 268 to which a plurality slitter blades 272 are secured. Preferably, slitter blades 272 are permanently secured to base 268, such as by welding or by integrally forming slitter blades 272 with base 268. Although slitter pack 264 is shown including a particular set of slitter blades 272, it is expressly contemplated that slitter blades 272 may be substituted by any of the slitter blades disclosed herein.

Base 268 may have any configuration suitable for supporting slitter blades 272 and for removably mounting to blade holder 104. Generally, slitter blades 272 may be arranged in any configuration described above with respect to slitter blades 224, and base 268 may be sized to accommodate the slitter blades. In the example shown, base 268 is sized to provide a common base to all of slitter blades 272. In alternative embodiments, base 268 may extend below only a portion of slitter blades 272. For example, base 268 may extend below and directly connect to a first group of slitter blades 272, while the other slitter blades 272 may be directly or indirectly connected to at least one of the slitter blades 272 in the first group of slitter blades 272.

Slitter pack 264 may be removably connected to blade holder 104 in any suitable fashion for positioning slitter blades 272 to extend axially between upstream and downstream ends 120 and 124. In the illustrated example, slitter pack 264 is fastened to upstream surface 108 by fasteners 276. In alternative embodiments, slitter pack 264 may be fastened by welds, or bolts. Optionally, blade holder 104 may include a recess for receiving at least a portion of slitter pack 264. In the example shown, upstream surface 108 includes a recess 280 for receiving base 268 of slitter pack 264. Preferably, base 268 is flush with the surrounding upstream surface 108. This may prevent base 268 from interfering with potatoes which are in contact with upstream surface 108 during cutting. Also, the fastening means (e.g. welds or screws) are preferably level with or recessed below the surrounding upstream surface 108 for the same reason.

In alternative embodiments (not shown), slitter pack 264 may be mounted to downstream surface 112. For example, base 268 may be mounted in contact with downstream surface 112 with slitter blades 272 extending upstream, through an aperture (not shown) in upstream surface 108, to above upstream surface 108.

In some embodiments, blade holder 104 includes one or more axial apertures 284. Where blade assembly 100 is positioned in a flow path of a hydraulic cutting system (such as cutting system 10), apertures 284 may provide passages for hydraulic fluid (e.g. water) to pass through blade assembly 100. In turn, this may reduce the pressure exerted upon blade assembly 100 by the hydraulic fluid that propels food products into blade assembly 100. Further, this may reduce the impedance by blade assembly 100 to the flow of hydraulic fluid, which may permit the hydraulic fluid to flow at higher velocities and flow rates.

Optionally, blade assembly 100 may further include a mounting fixture that secures to blade holder 104 for making blade assembly 100 compatible for mounting in a cutting device. Preferably, the mounting fixture is releasably secured to the blade holder 104. This may permit the blade holder to be removed and replaced if damaged or to change the cutting pattern. This may also permit the blade holder 104 to be mounted in different mounting fixtures, which may provide compatibility with different cutting devices.

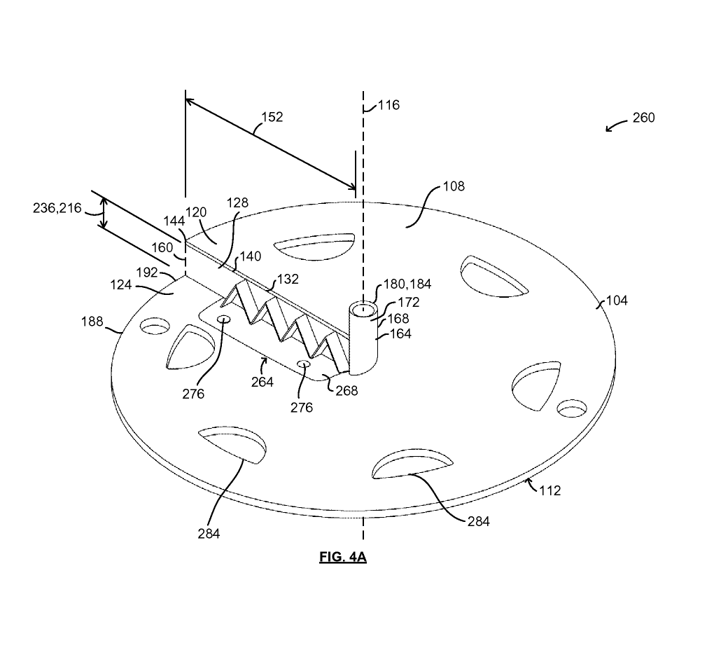

Reference is now made to FIGS. 5A-5C, which show blade assembly 100 including an exemplary mounting fixture 288 removably mounted to blade holder 104. In the example shown, mounting fixture 288 includes an upstream portion 292 and a downstream portion 296 that axially sandwich blade holder 104. Preferably, each of upstream and downstream portions 292 and 296 form a ring that is secured to a periphery of a respective upstream or downstream surface 108 or 112 of blade holder 104. As shown, each of upstream and downstream portions 292 and 296 define a central opening that provides unobstructed passage for potatoes to enter blade holder 104, and for sliced potatoes pieces exiting from blade holder 104.

Mounting fixture 288 may be permanently or removably mounted to blade holder 104 in any suitable fashion. For example, mounting fixture 288 may be secured to blade holder 104 by screws 300 as shown, bolts, welds, or rivets. In the illustrated example, upstream portion 292, and blade holder 104 include screw apertures 302 that align with threaded screw bores 308 in downstream portion 296, for screws 300. In some embodiments, slitter pack 264 may be secured to mounting fixture 288 (e.g. by fasteners, or welds) instead of fastening to blade holder 104. In this case, mounting the mounting fixture 288 to blade holder 104 may position slitter blades 272 of slitter pack 264 between upstream and downstream ends 120 and 124.

Preferably, the upstream portion 292 and downstream portion 296 of mounting fixture 288 are shaped to mate with upstream and downstream surfaces 108 and 112, respectively, of blade holder 104. This may permit mounting fixture 288 to provide structural rigidity to blade holder 104 for withstanding stresses from impacts by potatoes and from cutting potatoes. In the illustrated example, a downstream surface 308 of upstream portion 292 has a spiral shape that conforms to the spiral shape of blade holder upstream surface 108, and an upstream surface 312 of downstream portion 296 has a spiral shape that conforms to the spiral shape of blade holder downstream surface 112. This allows downstream surface 308 to lie flush against upstream surface 108, and allows upstream surface 312 to lie flush against downstream surface 112 (as best shown in FIG. 5C). In alternative embodiments, mounting fixture 288 may not be shaped to mate with upstream and downstream surfaces 108 and 112 of blade holder 104. For example, there may be one or more gaps between upstream portion 292 and upstream surface 108, and between downstream portion 296 and downstream surface 112.

Reference is now made to FIG. 6, which shows an exemplary food cutting device 316 including blade assembly 100, an uncut potato 200, and sliced potato pieces 240. In the illustrated example, food cutting device 316 includes an indirect drive 320. As shown, indirect drive 320 includes an electric motor 324 that drives a belt 328 to rotate blade assembly 100 in the direction 208 of rotation. Belt 328 may be drivingly connected to blade assembly 100 in any suitable fashion.

Referring now to FIGS. 1 and 6, food cutting device 316 is an example of a suitable knife fixture 22 for use with hydraulic cutting system 10, potato 200 is an example of a suitable food product 12 for cutting by knife fixture 22, and potato pieces 240 are examples of small food pieces 26 cut by knife fixture 22. In use, food cutting device 316 may be positioned in the flow path of hydraulic cutting system 10 and operated to rotate blade assembly 100. Potatoes 200 may then be propelled into blade assembly 100 by the food conveying system. Potato pieces 240 cut by blade assembly 100 of food cutting device 316 may be discharged downstream, optionally for further processing and/or packaging.

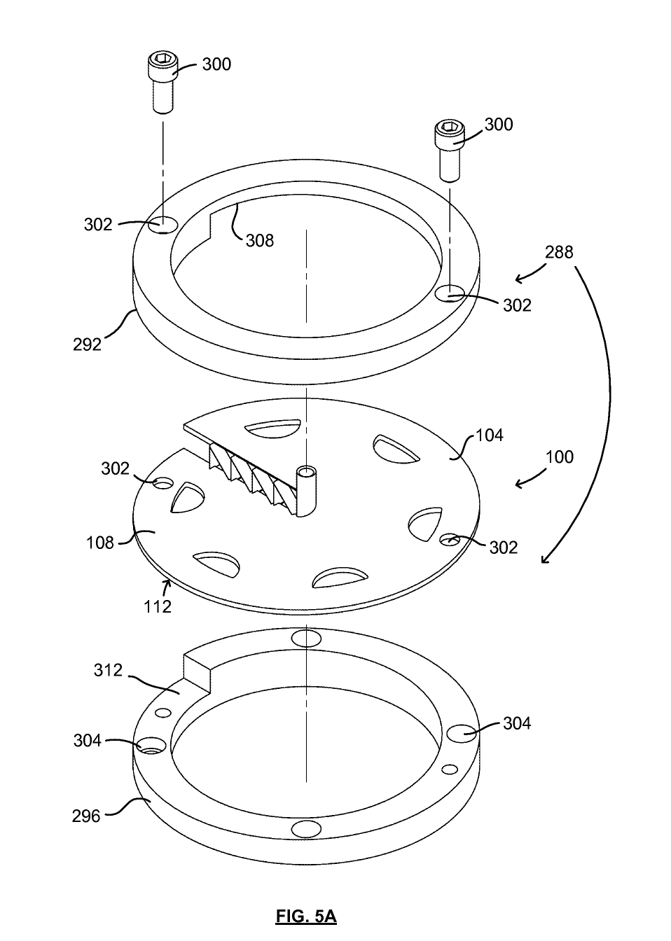

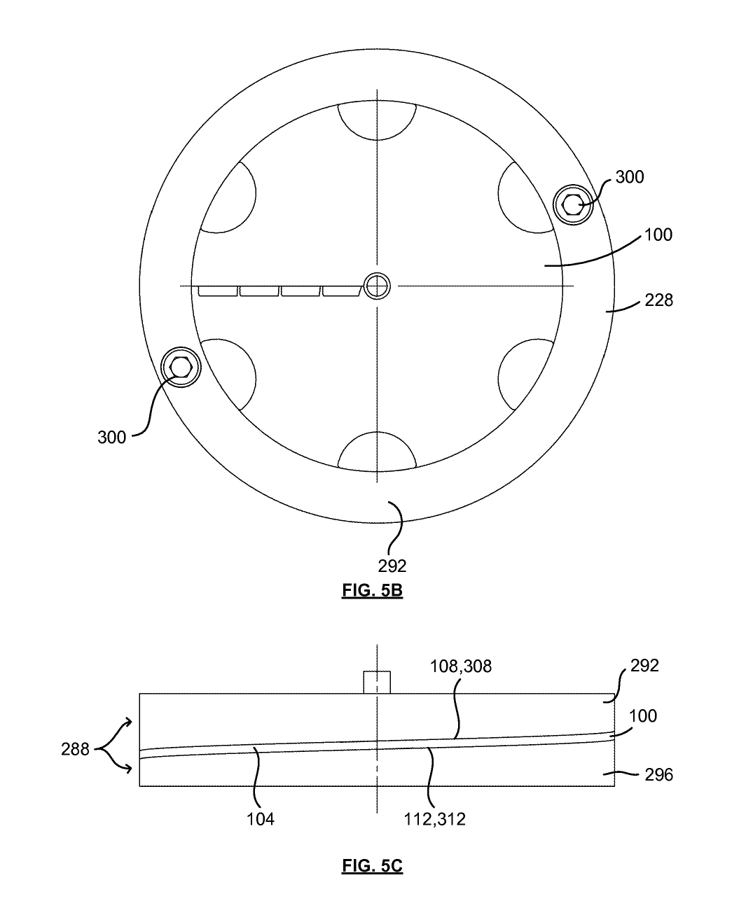

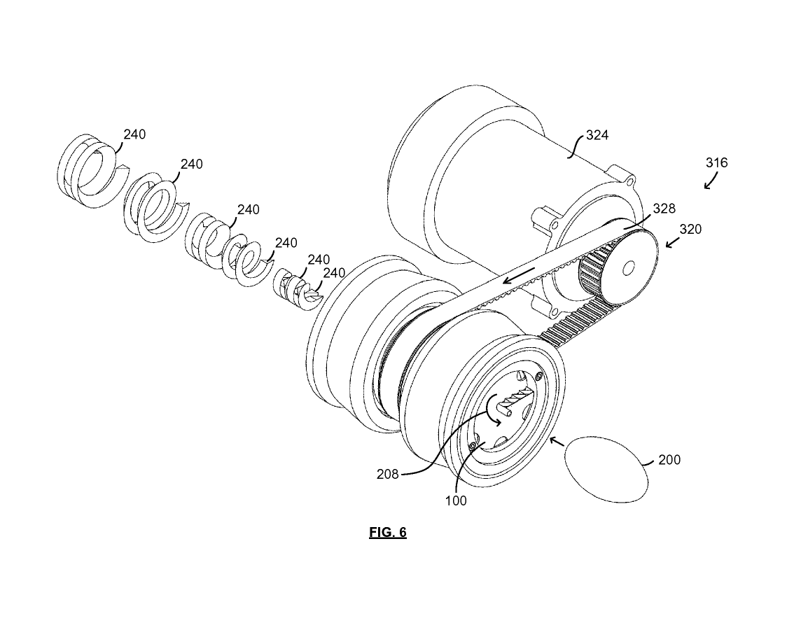

Reference is now made to FIGS. 7A-7E, where like part numbers refer to like parts, and where a blade assembly 350 is shown in accordance with another embodiment. Blade assembly 350 may be similar to blade assembly 100 except, for example, the shape of slitter blades 354. The description above with respect to slitter blades 224 regarding height, contact and connection between blades, rotary position, mounting to blade holder 104, and mounting to a slitter pack 264 applies mutatis mutandis to slitter blades 354.

In the illustrated example, slitter blades 354 in combination with blade holder 104 cut potato 200 into a plurality of smaller potato pieces 358 having triangular cross-sections. As shown, slitter blades 354 include a plurality of slitter blades 354a which alternate in radial position with a plurality of slitter blades 354b. Slitter blades 354a have cutting edges 244 that extend non-perpendicularly to the upstream surface 108 toward the axis 116 of rotation. Slitter blades 354b have cutting edges 244 that extend non-perpendicularly to the upstream surface 108 away from the axis 116 of rotation. Cutting edges 244 of each of slitter blades 354a and 354b may form any suitable angle with upstream surface 108 and axis 116. For example, cutting edges 244 of each of slitter blades 354a and 354b may be angled approximately 60 degrees from upstream surface 108 or approximately 30 degrees from axis 116 for cutting potato pieces 358 with equilateral triangular cross-sections as shown.

Alternatively, cutting edges 244 of slitter blades 354a and 354b may be angled at a plurality of differing angles to upstream surface 108 or axis 116 for providing potato pieces 358 having a variety of triangular cross-sections. This may provide a more varied “homestyle” appearance, which may be appealing to some consumers.

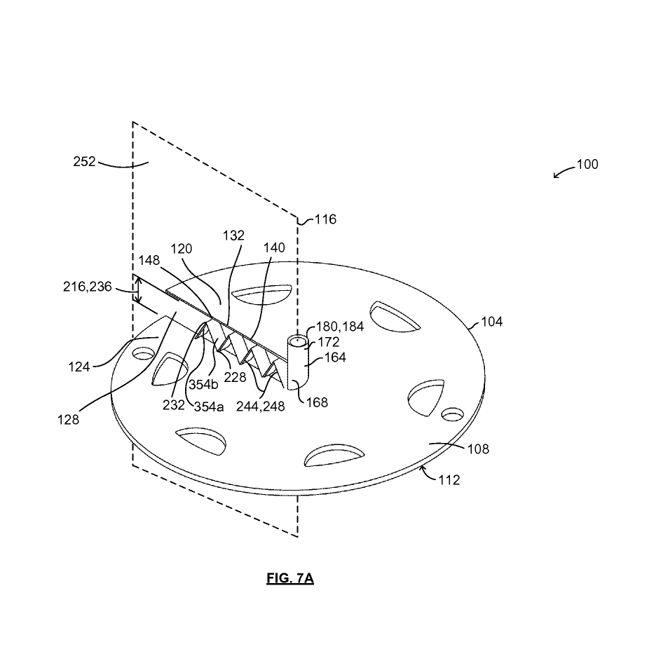

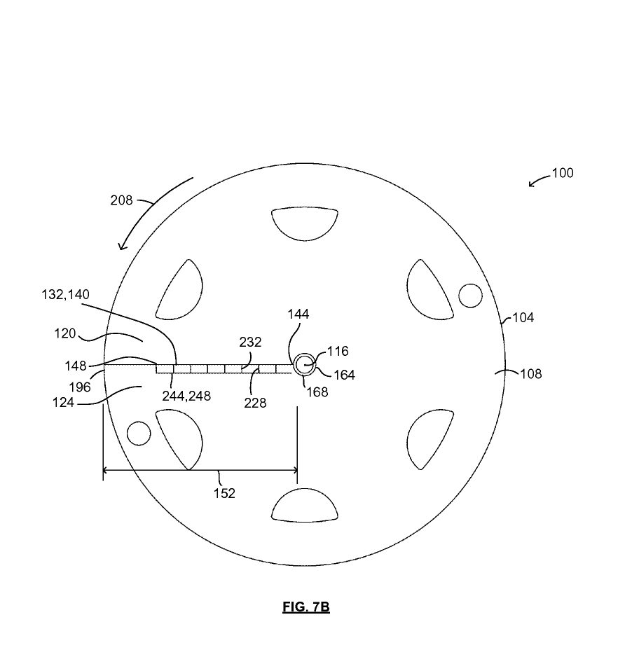

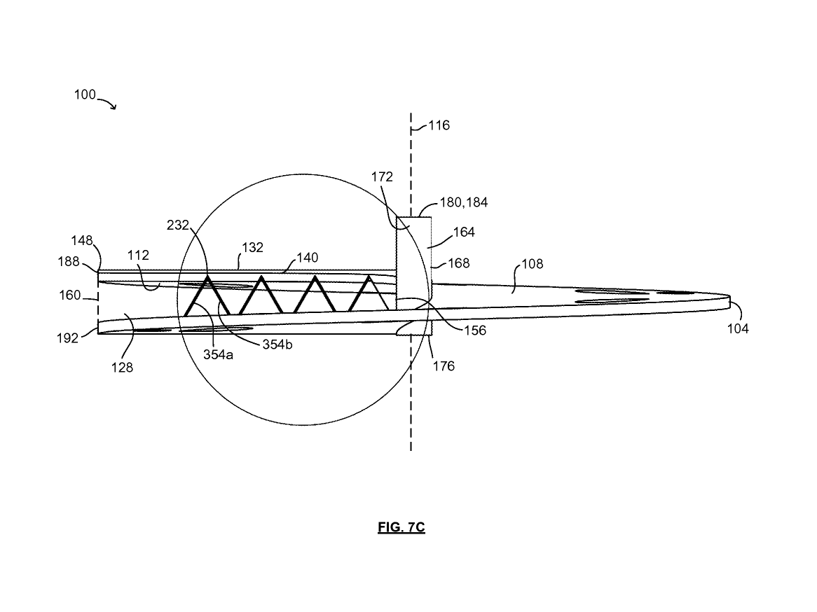

Reference is now made to FIGS. 8A-8D, where like part numbers refer to like parts, and where a blade assembly 370 is shown in accordance with another embodiment. Blade assembly 370 may be similar to blade assembly 100 except, for example, the shape of slitter blades 374. The description above with respect to slitter blades 224 regarding height, rotary position, mounting to blade holder 104, and mounting to a slitter pack 264 applies mutatis mutandis to slitter blades 374.

In the illustrated example, slitter blades 374 are radially distributed and spaced apart from each other. Each of slitter blades 374 is shown including a wavy (i.e. undulating) cutting edge 244. Each cutting edge 244 has an axial wavelength and a radial amplitude. Cutting edges 244 may each include any suitable number of waves (e.g. 1 to 25 waves), and may include the same or a different number of waves compared to the cutting edges 244 of other slitter blades 374. In the illustrated example, each slitter blade 374 includes a cutting edge 244 having approximately two and a half waves.

Whereas the cutting edges 244 of slitter blades 224 (FIGS. 2A-2C) are shown extending linearly in a single direction from one end to the other, cutting edges 244 of slitter blades 374 (and the slitter blade embodiments described below) may be described as including a plurality of different portions which extend in different directions in a plane parallel to axis 116 (such as plane 252). For example, a first portion 378 of slitter blade 374 extends in a first direction 380 away from axis 116, and a second portion 382 of the slitter blade 374 extends in a second direction 384 toward axis 116. Effectively, any cutting edge 244 that is non-linear in a plane parallel to axis 116 may satisfy this characteristic.

Referring particularly to FIGS. 8A, 8C and 8D, a potato 200 may be optionally pre-pierced by a piercing knife 390 before cutting with blade assembly 370. As shown, piercing knife 390 may form spaced apart piercings 392. Preferably, piercings 392 extend to an axial centerline of potato 200. In use, potato pieces cut by blade assembly 370 are axially divided into shortened pieces 394 by piercings 392 where the potato pieces intersect a piercing 392. Accordingly, the width 390 of piercings 392 should be approximately equal to the axial height 216 of slot 128 or cross-sectional height 212 of sliced potato 204, and spaced apart to align with the spiral cutting pattern of sliced potato 204. Although pre-piercing is described with respect to blade assembly 370, pre-piercing may also be used in combination with any other blade assembly or cutting device described herein.

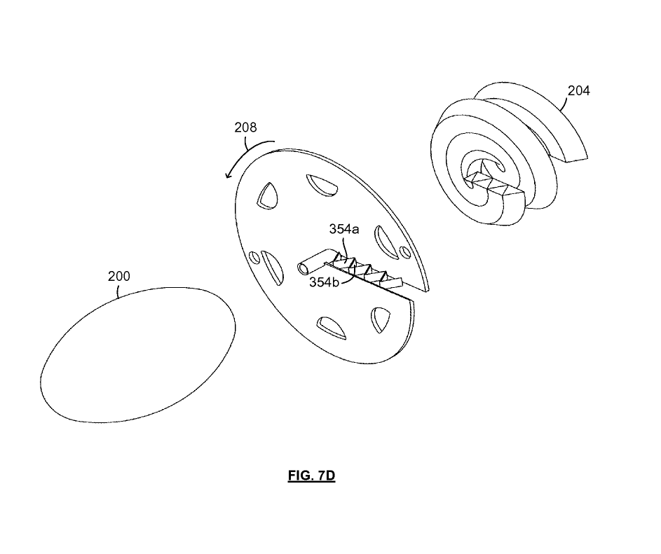

Reference is now made to FIGS. 9A and 9B, where like part numbers refer to like parts, and where a blade assembly 400 is shown in accordance with another embodiment. Blade assembly 400 may be similar to blade assembly 100 except, for example, the shape of slitter blades 404. The description above with respect to slitter blades 224 regarding height, rotary position, mounting to blade holder 104, and mounting to a slitter pack 264 applies mutatis mutandis to slitter blades 404.

In the illustrated example, slitter blades 374 are radially distributed and spaced apart from each other. Each slitter blade 374 includes a zigzagged cutting edge 244. As shown, each cutting edge 244 includes a plurality of alternating hills 408 and valleys 412 having an axial wavelength 416 and a radial amplitude 420. Cutting edges 244 may each include any suitable number of hills and valleys (e.g. 1 to 25 hills and valleys), and may include the same or a different number of hills and valleys compared to the cutting edges 244 of other slitter blades 404. In the illustrated example, each slitter blade 404 includes a cutting edge 244 having three valleys between four hills.

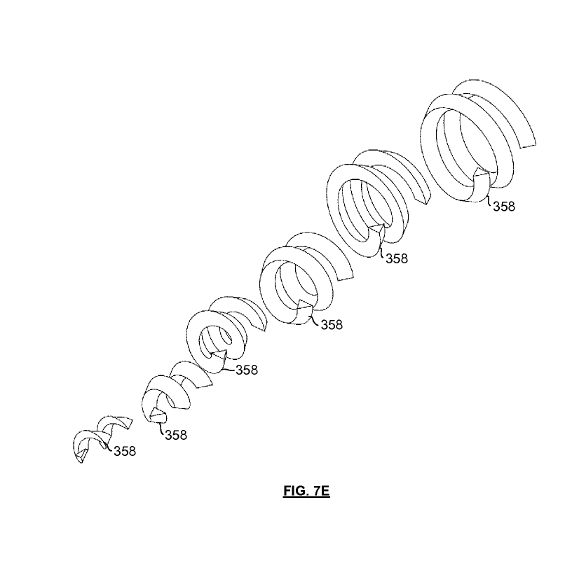

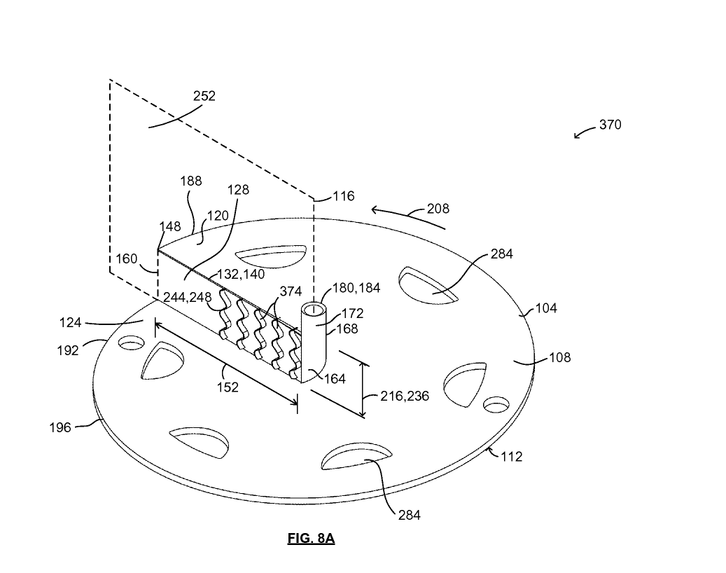

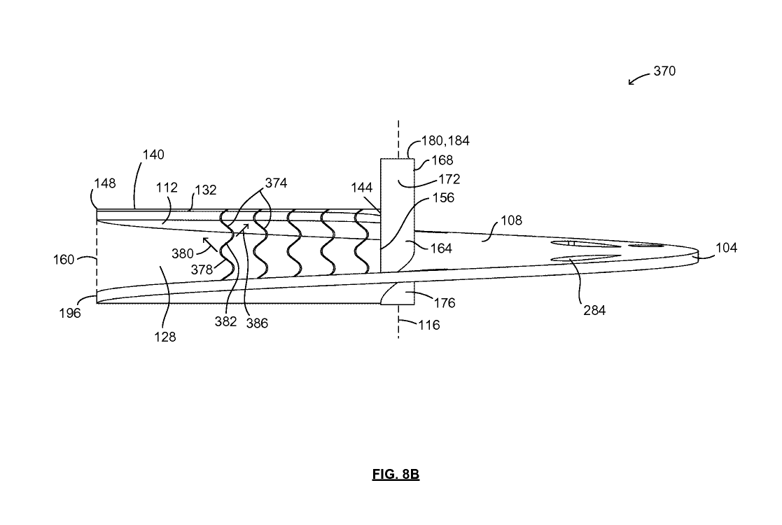

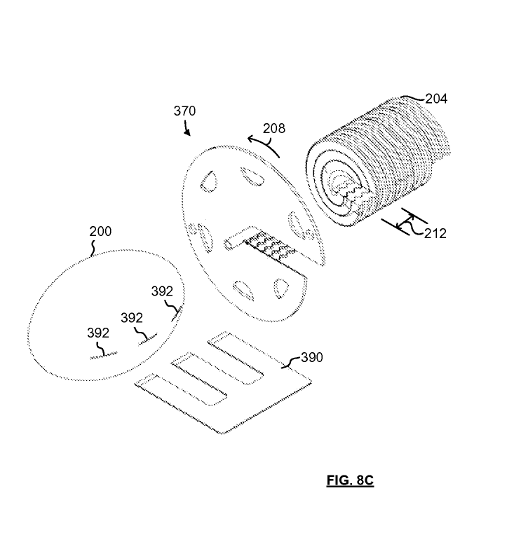

Reference is now made to FIGS. 10A-10F, where like part numbers refer to like parts, and where a blade assembly 440 is shown in accordance with another embodiment. Blade assembly 440 may be similar to blade assembly 100 except, for example, the shape of slitter blades 444. The description above with respect to slitter blades 224 regarding height, contact and connection between blades, rotary position, mounting to blade holder 104, and mounting to a slitter pack 264 applies mutatis mutandis to slitter blades 444.

In the illustrated example, each of slitter blades 444 has a cutting edge 244 with a curved shape, where a concave side faces radially outwardly (i.e. away from axis 116). Preferably, cutting edges 244 are arcuate and form a sector of a circle or oval. Each cutting edge 244 may form any portion of a circle or oval. For example, each cutting edge 244 may form from 10 degrees to 180 degrees of a circle or oval. In the illustrated example, cutting edges 244 each form approximately 180 degrees of a circle.

Each cutting edge 244 may be identical in shape as shown, or alternatively one or more of cutting edges 244 may be differently shaped (e.g. form a greater portion of a circle or oval). Further, each cutting edge 244 may be spaced apart from each other cutting edge 244 as shown, or in contact with the cutting edge 244 of an adjacent slitter blade 444 (and optionally joined permanently together at the point of contact).

In use, blade assembly 440 may be used to cut a plurality of potato pieces 448 from a potato. As shown, potato piece 448 has a spiral shape with a convex interior surface 452 and a concave exterior surface 456.

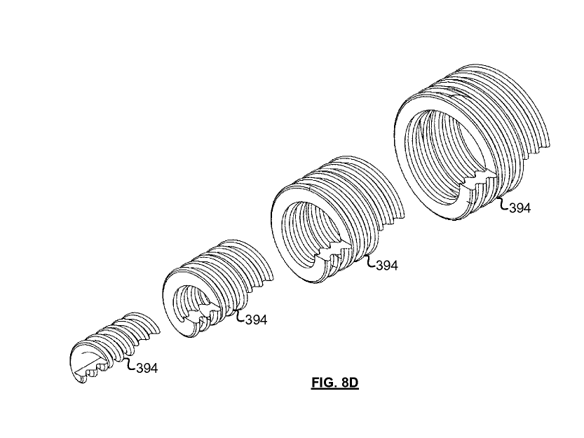

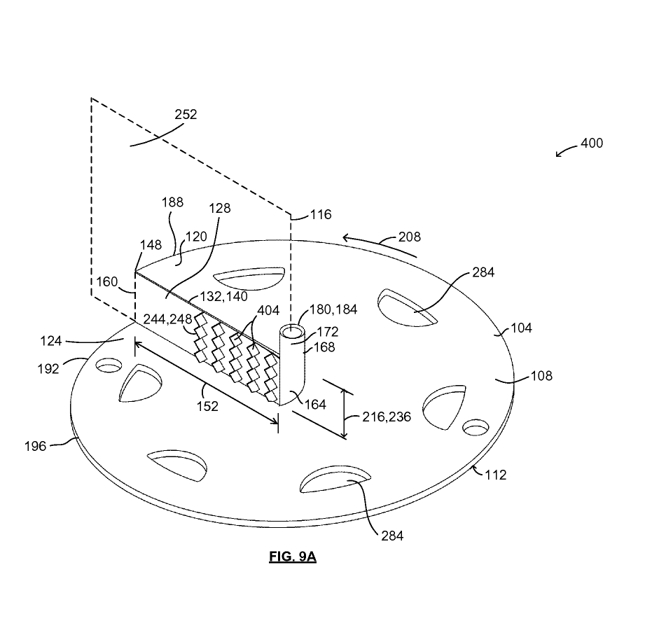

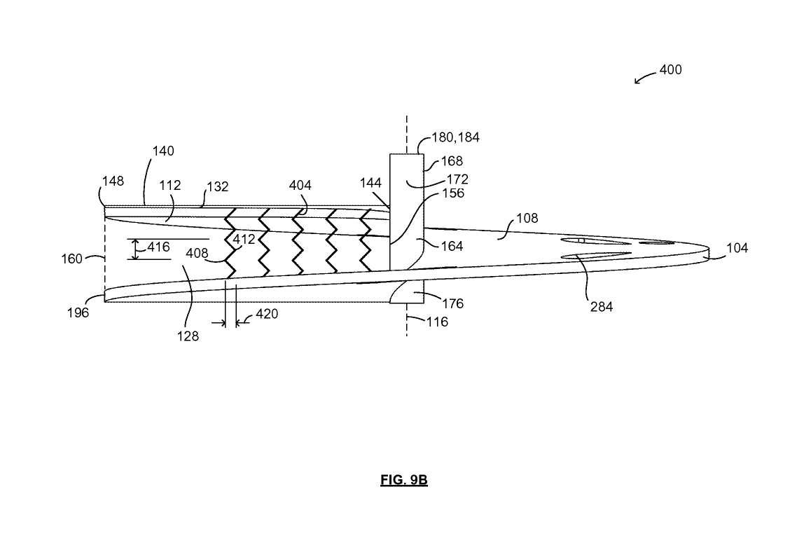

Referring to FIGS. 11A-11F, in an alternative embodiment, cutting edges 244 of slitter blades 444 may have a concave side that faces radially inwards (i.e. towards axis 116). In this case, the potato piece 448 cut by blade assembly 440 has a concave interior surface 452 and a convex exterior surface 456.

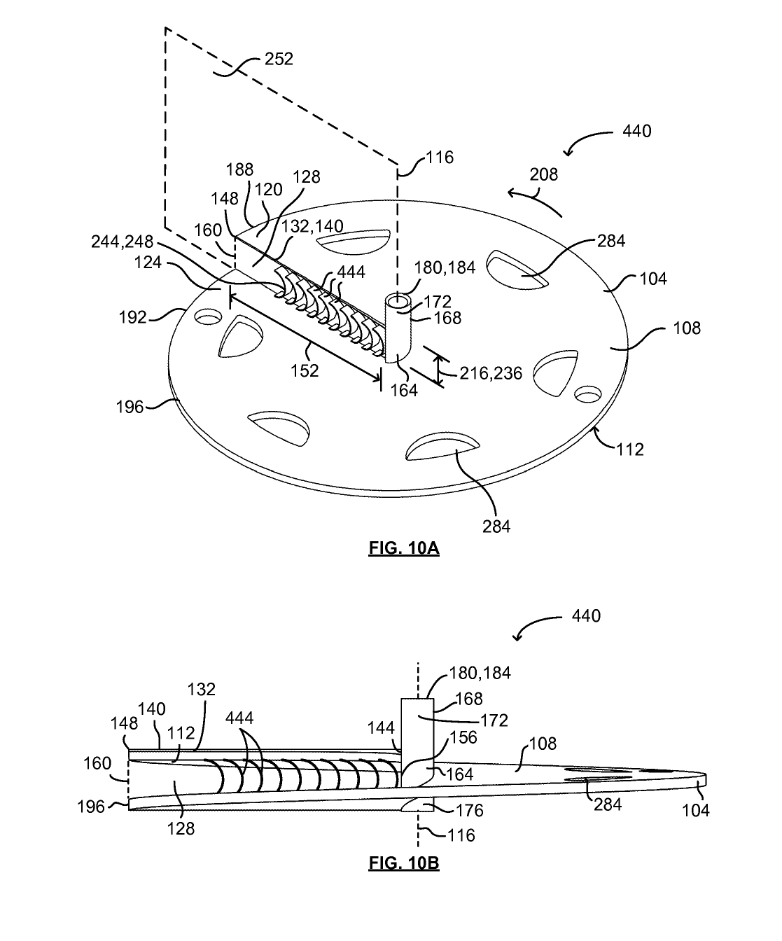

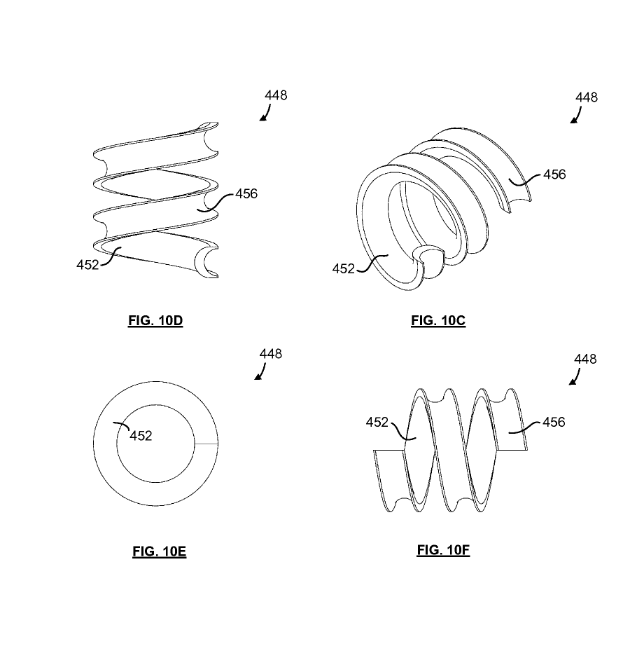

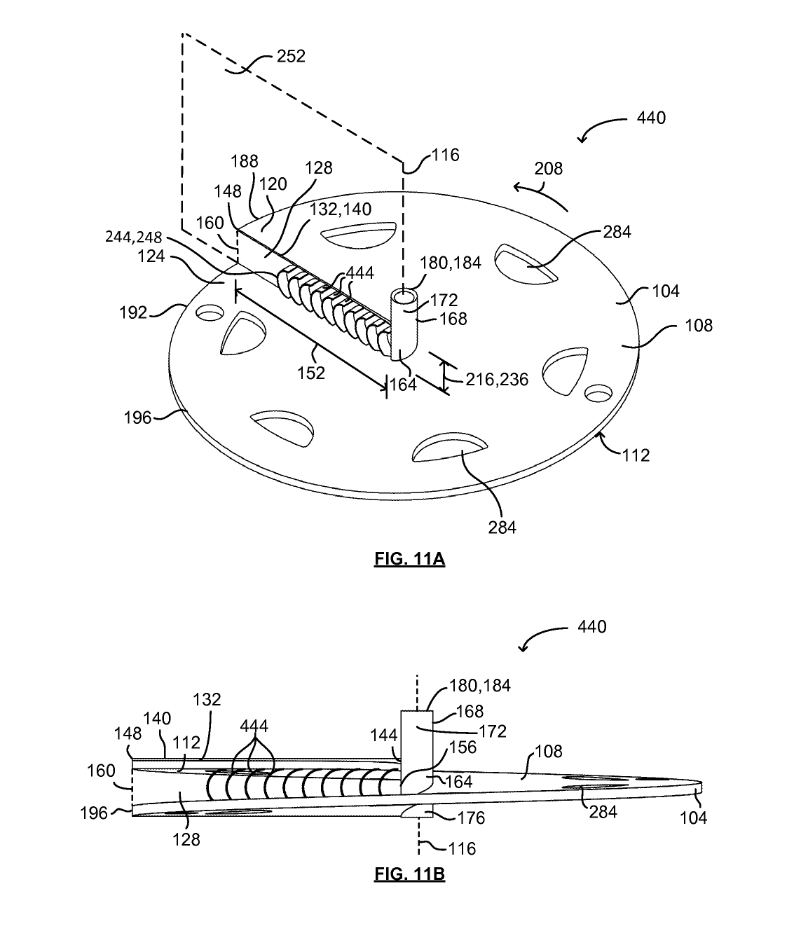

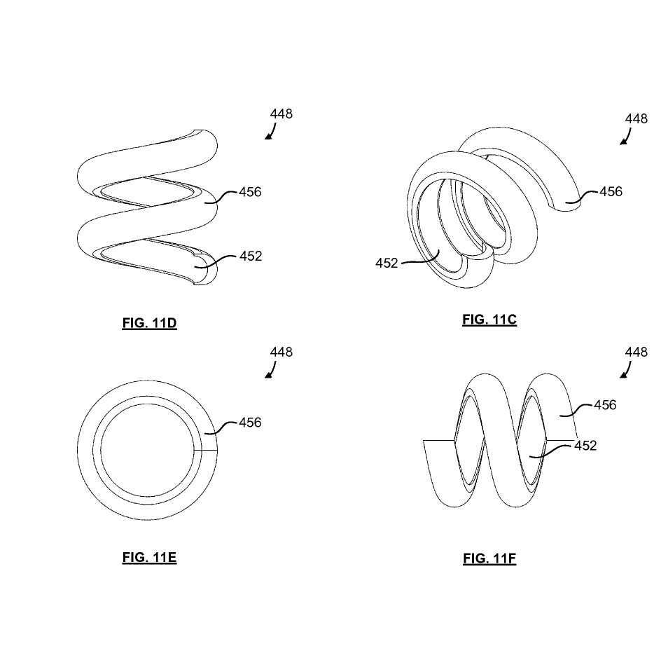

Reference is now made to FIGS. 12A-12F, where like part numbers refer to like parts, and where a blade assembly 480 is shown in accordance with another embodiment. Blade assembly 480 may be similar to blade assembly 100 except, for example, the shape of slitter blades 484. The description above with respect to slitter blades 224 regarding height, contact and connection between blades, rotary position, mounting to blade holder 104, and mounting to a slitter pack 264 applies mutatis mutandis to slitter blades 484.

In the illustrated example, each slitter blade 484 includes a cutting edge 244 that forms a closed crescent shape. As shown, each cutting edge 244 includes an arcuate upstream portion 488 and a downstream portion 492 which meet and are joined together at opposite radially inboard and outboard ends 496 and 500 of the cutting edge 244. In the example shown, upstream and downstream portions 488 and 492 each have an upstream surface 504 that is convex to form a crescent shape. In an alternative embodiment, the upstream surface 504 of upstream and downstream portions 488 and 492 may be concave. Optionally, slitter blades 484 may contact and be optionally joined to radially adjacent slitter blades 484 at radially inboard and outboard ends 496 and 500 as shown.

In use, blade assembly 480 may be used to cut a plurality of potato pieces 508 from a potato. As shown, potato piece 508 has a spiral shape with a concave downstream surface 512 and a convex upstream surface 516.

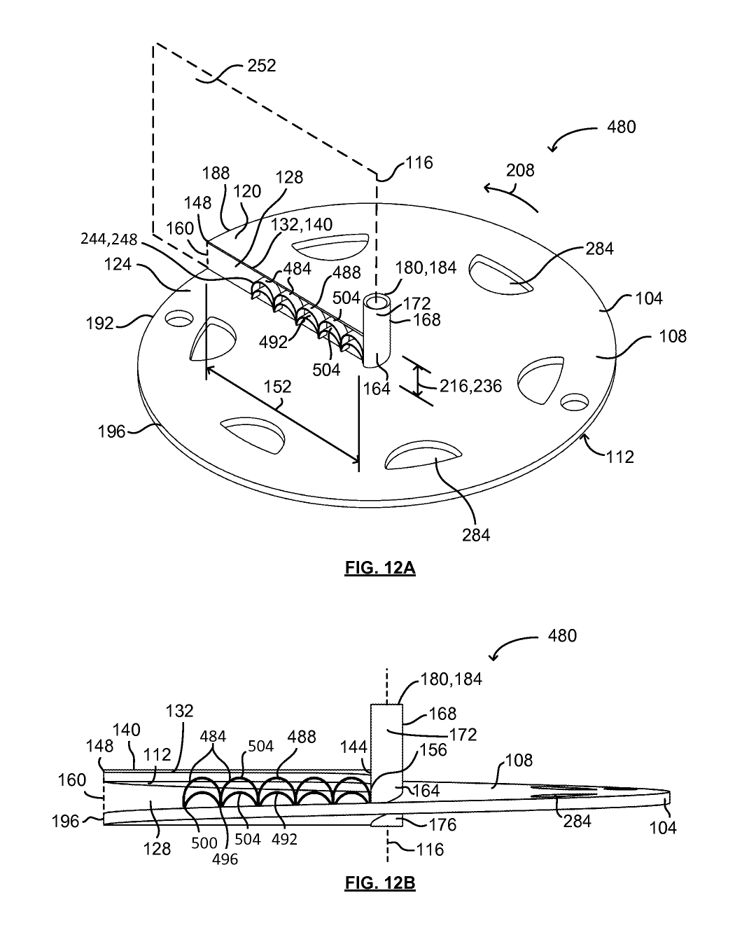

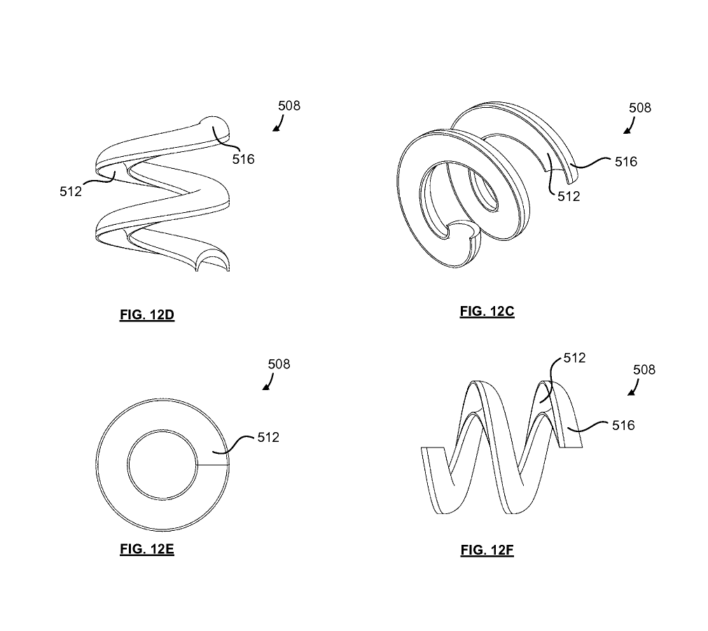

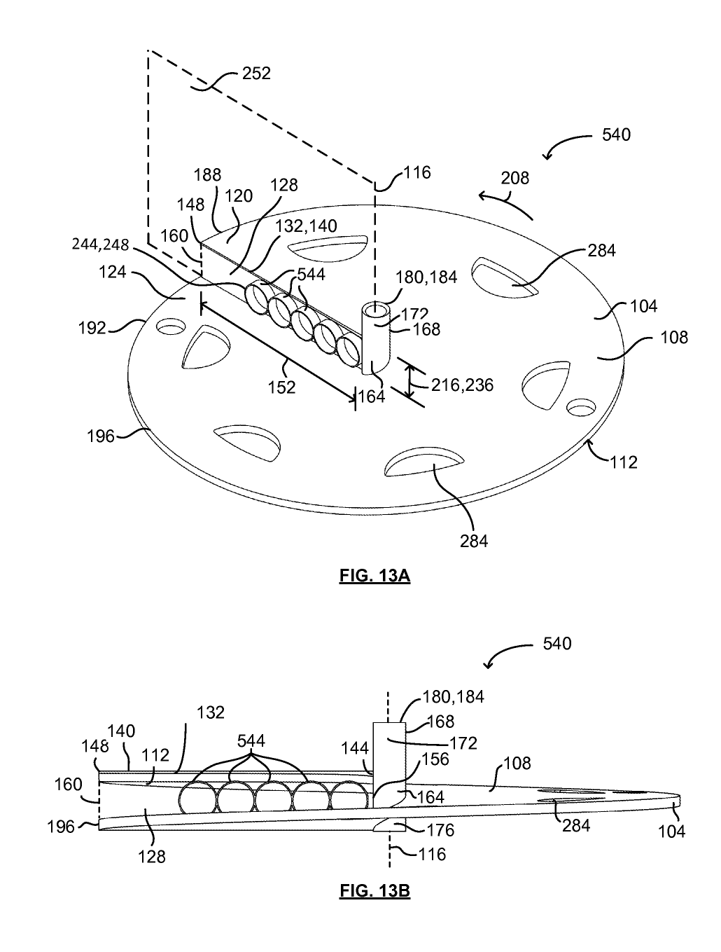

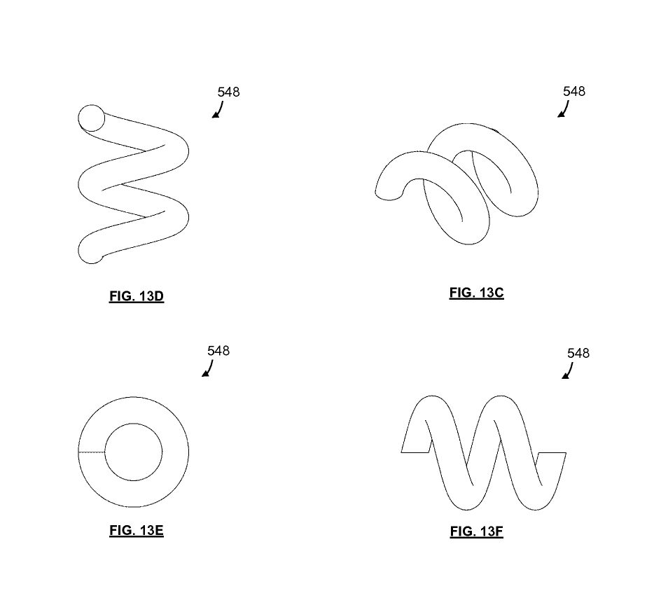

Reference is now made to FIGS. 13A-13F, where like part numbers refer to like parts, and where a blade assembly 540 is shown in accordance with another embodiment. Blade assembly 540 may be similar to blade assembly 100 except, for example, the shape of slitter blades 544. The description above with respect to slitter blades 224 regarding height, contact and connection between blades, rotary position, mounting to blade holder 104, and mounting to a slitter pack 264 applies mutatis mutandis to slitter blades 544.

In the illustrated example, cutting edge 244 of each slitter blade 544 has a closed circular shape. Preferably, cutting edge 244 of each slitter blade 544 forms a circle, as shown, however in alternative embodiments one or more of slitter blades 544 may include a cutting edge 244 that form an oval. As shown, slitter blades 544 may be positioned side-by-side in touching relationship, so that each slitter blade 544 is in contact with one or more adjacent slitter blades 544. Optionally, the cutting edge 244 of each slitter blade 544 may be in contact with the cutting edge 244 of one or more adjacent cutting edges 244. This may reduce the quantity of waste potato after cutting.

In use, blade assembly 540 may be used to cut a plurality of potato pieces 548 from a potato. As shown, potato piece 548 has a spiral shape with a circular cross-section.

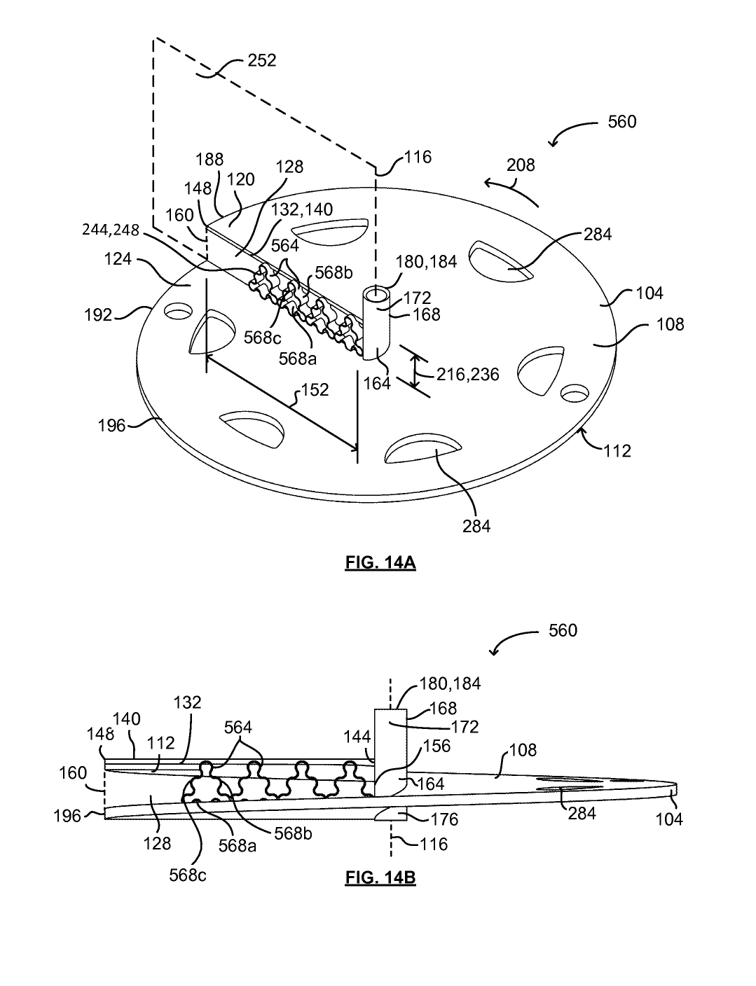

Reference is now made to FIGS. 14A and 14B, where like part numbers refer to like parts, and where a blade assembly 560 is shown in accordance with another embodiment. Blade assembly 560 may be similar to blade assembly 100 except, for example, the shape of slitter blades 564. The description above with respect to slitter blades 224 regarding height, contact and connection between blades, rotary position, mounting to blade holder 104, and mounting to a slitter pack 264 applies mutatis mutandis to slitter blades 564.

In the illustrated example, each slitter blade 564 includes a cutting edge 244 that forms a closed triangular shape with wavy (i.e. undulating) sides 568. The triangular shape may be arranged in any suitable orientation. In the example shown, one side 568a is oriented substantially parallel to and extending along upstream surface 108, and two sides 568b and 568c extend from different ends of side 568a upstream at an angle to axis 116 and join together at an upstream side 140 of slot 128. In alternative embodiments, the triangular arrangement of sides 568 may be rotated in a plane parallel to axis 116 (e.g. such that side 568a is parallel to and extending along upstream side 140 of slot 128).

As shown, wavy sides 568 of cutting edge 244 are characterized by a wavelength and amplitude. Wavy sides 568 may have any suitable wavelength and amplitude. Preferably, the wavelength and amplitude of wavy sides 568 is consistent across cutting edge 244. Optionally, the wavelength and amplitude of wavy sides 568 may vary from one side 568 to another, and/or within each side 568.

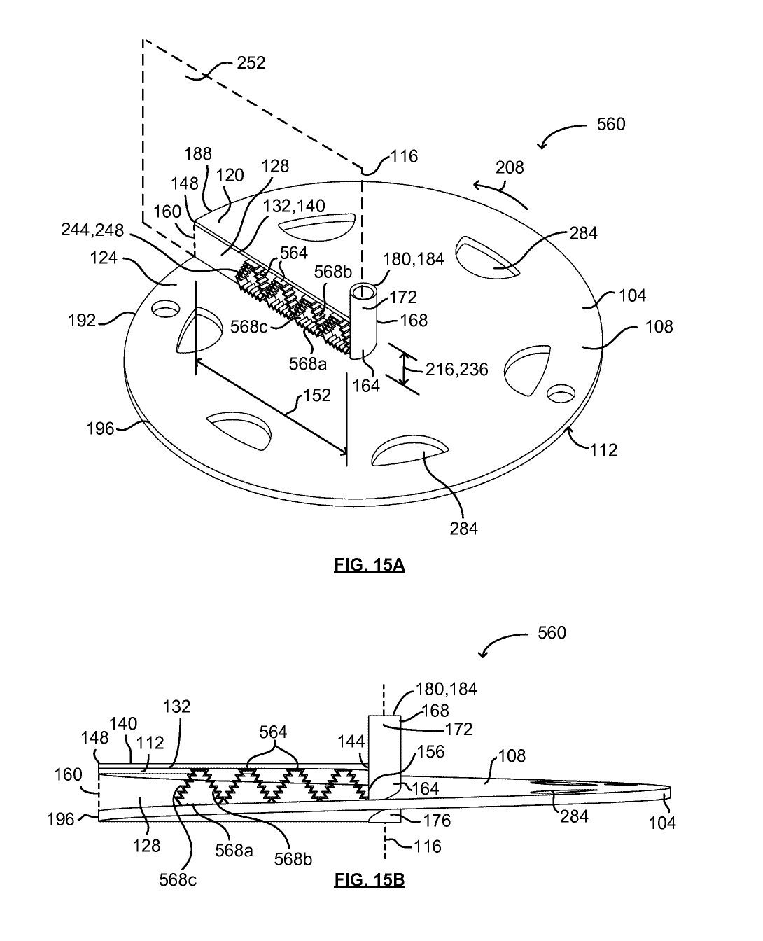

In the illustrated example, sides 568 form an equilateral triangle. It will be appreciated that in alternative embodiments, sides 568 may be arranged to form any other triangle, such as an isosceles triangle, a scalene triangle, an acute triangle, a right angled triangle, or an obtuse triangle. Further, in an alternative embodiment, sides 568 of cutting edge 244 may be zigzagged instead of wavy as shown in FIGS. 15A and 15B.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A rotary blade assembly for cutting a food product into helical strips, the rotary blade assembly comprising:
a substantially spiral-shaped blade holder for mounting in a food product flow path, the blade holder comprising:
an axis of rotation,
an upstream surface,
an upstream end and a downstream end, the upstream end being axially spaced apart from the downstream end to define a radial slot,
a radial cutting edge adjacent the radial slot; and
a plurality of axially extending slitter blades connected to the blade holder, each slitter blade extending upstream of the upstream surface, each slitter blade including a slitter cutting edge,
wherein at least a portion of the slitter cutting edge of at least one of the slitter blades extends substantially non-perpendicularly to the upstream surface toward or away from the axis of rotation.

2. The rotary blade assembly of claim 1, wherein at least a portion of each slitter cutting edge is curved.

3. The rotary blade assembly of claim 1, wherein at least one of the slitter blades of the plurality of slitter blades is in contact with an adjacent other slitter blade of the plurality of slitter blades.

4. The rotary blade assembly of claim 1, wherein the slitter cutting edge of at least one of the slitter blades forms a closed shape.

5. The rotary blade assembly of claim 1, wherein the slitter cutting edge comprises at least a first portion and a second portion, the first and second portions extending in different directions in the plane that is substantially parallel to the axis of rotation.

6. The rotary blade assembly of claim 1, wherein the slitter cutting edge of alternate slitter blades is substantially perpendicular to the upstream surface.

7. The rotary blade assembly of claim 2, wherein the portion of each slitter cutting edge is undulating.

8. The rotary blade assembly of claim 2, wherein the slitter cutting edge of each slitter blade is arcuate.

9. The rotary blade assembly of claim 4, wherein the slitter cutting edge of each slitter blade is crescent shaped.

10. The rotary blade assembly of claim 4, wherein the slitter cutting edge of each slitter blade is circular.

11. The rotary blade assembly of claim 5, wherein the slitter cutting edge of each slitter blade is zigzagged.

12. The rotary blade assembly of claim 1, wherein each slitter blade extends from the downstream end to the upstream end of the blade holder.

13. The rotary blade assembly of claim 1, further comprising a slitter pack removably mounted to the blade holder, the slitter pack including the plurality of slitter blades.

14. The rotary blade assembly of claim 1, wherein each of the plurality of slitter blades is positioned a different radial distance from the axis of rotation.

15. The rotary blade assembly of claim 1, wherein the blade holder further comprises a slab blade removably mounted proximate the upstream end, the slab blade including the radial cutting edge.

16. A rotary blade assembly for cutting a food product into helical strips, the rotary blade assembly comprising:
a blade holder having an axis of rotation, an upstream surface, and a radially extending leading edge spaced from at least a portion of the upstream surface to define a slot having an axial height and a radial width; and
a plurality of slitter blades, each slitter blade extending axially away from the upstream surface, and each slitter blade including a cutting edge,
wherein at least a portion of the cutting edge of at least one of the slitter blades extends substantially non-perpendicularly to the upstream surface in a plane substantially parallel to the axis of rotation.

17. The rotary blade assembly of claim 16, wherein at least a portion of each cutting edge is curved.

18. The rotary blade assembly of claim 16, wherein at least one of the slitter blades of the plurality of slitter blades is in contact with an adjacent other slitter blade of the plurality of slitter blades.

19. The rotary blade assembly of claim 16, wherein the cutting edge of at least one of the slitter blades forms a closed shape.

20. The rotary blade assembly of claim 16, wherein the cutting edge of each of the plurality of slitter blades includes at least a first portion and a second portion, the first and second portions extending in different directions in the plane that is substantially parallel to the axis of rotation.

21. A rotary blade assembly for cutting a food product into helical strips, the rotary blade assembly comprising:
a blade holder having an axis of rotation, an upstream surface, and a radially extending leading edge spaced from at least a portion of the upstream surface to define a slot having an axial height and a radial width; and
a plurality of slitter blades, each slitter blade extending axially away from the upstream surface, and each slitter blade including a cutting edge,
wherein at least a portion of the cutting edge of at least one of the slitter blades extends toward or away from the axis of rotation when viewed in profile through a viewing plane that is parallel to the axis of rotation.
